(19) United States
(12) Patent Application Publication
(10) Pub. No.: US 2010/0242174 A1
(43) Pub. Date: Sep. 30, 2010

(54) Adjustable Height Lift Platform for Surgical Procedures

(76) Inventors: Paul Morrison, SR., Fresno, CA (US); Kelvin Dwight Higa, Clovis, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/636,706

(22) Filed: Dec. 11, 2009

Related U.S. Application Data
(60) Provisional application No. 61/121,593, filed on Dec. 11, 2008.

(51) Int. Cl. A61G 13/00

(52) U.S. Cl. 5/507.1

(57) ABSTRACT

An adjustable height lift platform for a surgeon to stand on while he or she performs a surgical procedure that is comfortably and beneficially performed at a desired height. The lift platform comprises a base platform having a lower surface that rests on the floor, an upper platform having an upper surface on which the surgeon stands and a lifting mechanism that interconnects the base and upper platforms to raise and lower the upper platform. The lifting mechanism has a first linkage assembly pivotally connected to a second linkage assembly, slotted tracks at each of the base and upper platforms, cam followers associated with the linkage assemblies that are received in the slotted tracks and linear actuators that engage the linkage assemblies to pivot them in a scissor-like manner to raise and lower the upper platform. Preferably, a foot operated switch controls the movement and positioning of the upper platform.

### CROSS-REFERENCE TO RELATED APPLICATIONS

This patent application claims the benefit of U.S. Provisional Patent Application No. 61/121,593 filed Dec. 11, 2009.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to lift platforms on which a surgeon can stand while performing surgery on a patient laying on a hospital operating table or otherwise supported by a patient support apparatus.

In particular, the present invention relates to such lift platforms which can easily, smoothly and quickly raise or lower the surgeon in relation to the patient. Even more particularly, this invention relates to such lift platforms which collapse for storage and are easily moveable.

B. Background

One of the modern advances in medical procedures is the use of laparoscopic surgery, which is also referred to as minimally invasive surgery, to accomplish certain types of medical objectives. In particular, laparoscopic surgery is a medical technique that is utilized to perform complex surgical procedures in the abdominal or pelvic cavities through small incisions in the abdomen. In contrast to “open” surgery, which typically requires incisions large enough for the surgeon's hands to enter the patient, the incision for laparoscopic surgery is very small, typically only 0.5 to 1.5 cm in size, to allow the laparscope to be inserted into the patient. There are a number of well known advantages that result from the small incision required for laparoscopic surgery. One such the primary advantages is that the smaller incision reduces pain and recovery time for the patient, resulting in lower pain medication requirements and less time in the hospital. The smaller incision also reduces post-operative scarring and the likelihood of hemorrhaging during surgery, which reduces the chance of the patient needing a blood transfusion. A smaller incision also reduces exposure of the internal organs to possible contamination during the surgical procedure, thereby reducing the likelihood of infections resulting from the surgery.

Although laparoscopic surgery is widely recognized as being very beneficial, this type of surgical procedure does have certain disadvantages with regard to the potential physical impact on the surgeon. Because of the nature of the instrumentation and procedures utilized in laparoscopic surgery, the surgeon must be elevated in relation to the patient in order to effectively, efficiently and safely accomplish the surgery. Typically, the patient is laying on or otherwise beneficially positioned on an operating room table or other patient support apparatus. If the surgeon is not sufficiently elevated in relation to the patient, then the surgeon is exposed to shoulder, back and neck fatigue and carpal tunnel syndrome, all of which can be potentially damaging to the surgeon's ability to perform the surgery or his or her ability to comfortably (e.g., without pain) perform the surgery. Because laparoscopic surgeries and the like are known to be somewhat lengthy, it is important for the surgeon not suffer undue fatigue and/or discomfort while performing the surgery so that he or she may be able to perform at their best and not cause the surgery to take more time. In addition, continued exposure to such fatigue and discomfort can result in long term injury which can affect or limit the surgeon's career.

Although many operating tables are configured to raise and lower the patient relative to the floor of the operating room, the surgeon's need to be elevated in relation to the position of the patient is generally much more than can be accomplished by simply lowering the operating table. In addition, lowering the operating table a sufficient distance to be suitable for the surgeon performing the laparoscopic surgery, assuming such lowering is possible, can present problems for the remaining members of the surgical team. Additionally, the typical devices or mechanisms for raising and lowering operating tables are complex and are usually very expensive. As a result of the foregoing, the current state-of-the-art to properly position the surgeon relative to the patient on the operating table is to utilize stackable fixed height platforms that are stacked on top of each other to provide a standing surface at the height desired for the surgeon to perform the laparoscopic surgery. Although these platforms are nominally mobile, they are generally somewhat heavy and non-adjustable in height. The placement of the stackable platforms must be accomplished by nursing or non-surgical personnel so the surgeon can maintain sterility at all times. Movement of these platforms exposes these personnel, or anyone who must move one or more of the platforms alongside the operating table and, if necessary, stack one or more platforms on top of each other, to potential back issues and other safety issues. In addition, the presently utilized platforms are not easily stored and are often in the way when not in use.

What is needed, therefore, is an adjustable height platform on which a surgeon can stand to effectively and safely perform a surgical procedure, such as laparoscopic surgery. Such an adjustable height platform should be able to precisely adjust to the desired height so the surgeon can perform the surgery without harm to his or her shoulders, back, neck or wrists, particularly during long surgical procedures. Preferably, such a platform should allow the surgeon to adjust the height himself or herself without the assistance of other persons, thereby allowing the surgeon to change the height as may be necessary during the surgery and avoiding the need to instruct other persons on the correct height.

The preferred adjustable height platform should be configured so as to be stable for the surgeon, lightweight for ease of mobility and collapsible for ease of storage when not in use.

### SUMMARY OF THE INVENTION

The adjustable height lift platform for surgical procedures of the present invention provides the benefits and solves the problems identified above. That is to say, the present invention discloses an adjustable height lift platform for use by a surgeon when performing surgical procedures, such as laparoscopic surgery, on a patient laying on or otherwise supported by an operating table or the like. The adjustable height lift platform of the present invention is configured for a surgeon to stand on in order for him or her to more comfortably, effectively and safely perform the surgical procedure. In the preferred embodiment, the adjustable height lift platform of the present invention allows the surgeon to precisely adjust his or her position to the desired height relative to the patient so the surgeon can perform the surgery without strain or other harm to his or her shoulders, back, neck, wrists or other parts of the surgeon's body. The preferred embodiment of the present adjustable height lift platform is configured to allow the surgeon to adjust the height of the platform on which he or she stands without assistance from other persons so he or she may change the height of the platform as necessary during the surgery without having to instruct other persons regarding the correct height adjustment. The preferred adjustable height lift platform of the present invention is stable for the surgeon to stand on, lightweight for ease of mobility and collapsible for ease of storage.

In a primary embodiment of the present invention, the adjustable height lift platform generally comprises a base platform that rests on the floor of the operating room, an upper platform on which the surgeon stands while he or she is performing the surgery and a lifting mechanism that interconnects the base platform and the upper platform so as to move the lift platform between a collapsed position with the upper platform near the base platform and a raised position with the upper platform raised above the base platform. The base platform has a lower surface configured to rest on a floor and the upper platform has an upper surface sized and configured for the surgeon to stand on while performing the surgical procedure. In the preferred embodiment, the lifting mechanism has a first linkage assembly, a second linkage assembly, one or more upper slotted tracks at the upper platform, one or more lower slotted tracks at the base platform, one or more cam followers associated with the first linkage assembly and received in a slot of the lower slotted tracks, one or more cam followers associated with the second linkage assembly and received in a slot of the upper slotted track and a pivot assembly that pivotally interconnects the first and second linkage assemblies. In the preferred embodiment, each of the first linkage assembly and the second linkage assembly have a first linkage member, a second linkage member and a cross-member interconnecting the first and second linkage members. A switch operating mechanism is mounted on or disposed in the upper surface of the upper platform and is operatively connected to the lifting mechanism to move the lift platform between the collapsed position and the raised position to raise and lower the surgeon relative to the floor and to a patient laying on the operating table next to the lift platform. Preferably, the switch operating mechanism is operated by a foot of the surgeon so he or she does not have to use a hand to operate the lift platform. In the preferred embodiment, the base platform has one or more peripherally disposed upwardly extending sidewalls and the upper platform has one or more peripherally disposed downwardly extending sidewalls. The base platform has a handle at a first end and one or more wheels at a second end so the lift platform can be easily moved across the floor to the operating table or to its storage location.

Accordingly, the primary aspect of the present invention is to provide an adjustable height lift platform for surgical procedures that has the advantages discussed above and which overcomes the disadvantages and limitations that are associated with presently available apparatuses and systems for adjusting the height of a surgeon relative to a patient laying on or otherwise supported by an operating table or the like.

It is an important aspect of the present invention to provide an adjustable height lift platform that can be utilized by a surgeon while he or she is performing a surgical procedure, such as laparoscopic surgery, on a patient on an operating table to vary the surgeon's position relative to the patient so as to more effectively, efficiently, safely and comfortably perform the surgery.

It is also an important aspect of the present invention to provide an adjustable height lift platform that allows a surgeon to precisely adjust his or her height relative to a patient laying on an operating table to place the surgeon in a better position to perform a surgical procedure, particularly laparoscopic surgery, on the patient without strain or other harm to the surgeon's shoulders, back, neck, wrists or other parts of the surgeon's body.

It is also an important aspect of the present invention to provide an adjustable height lift platform that allows a surgeon standing on the platform to adjust the height of the platform relative to a patient laying on an operating table without assistance from other persons so the surgeon can adjust his or her height during a surgery without having to direct others to make the adjustment and without raising or lowering the operating table.

It is also an important aspect of the present invention to provide an adjustable height lift platform for use by a surgeon during a surgical procedure that is very stable for the surgeon to stand on, lightweight for ease of moving the platform into the desired position alongside an operating table and collapsible for ease of storage when not in use.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of an adjustable height lift platform for surgical procedures that is configured according to a preferred embodiment of the present invention shown in its raised position;

FIG. 2 is a side perspective view of the adjustable height lift platform of FIG. 1 shown in its collapsed position;

FIG. 3 is a left or first side view of the adjustable height lift platform of FIG. 1;

FIG. 4 is a right or second side view of the adjustable height lift platform of FIG. 1;

FIG. 5 is a front or first end view of the adjustable height lift platform of FIG. 1;

FIG. 6 is a back or second end view of the adjustable height lift platform of FIG. 1;

FIG. 7 is an exploded view of the adjustable height lift platform of FIG. 1;

FIG. 8 is a side perspective, partially exploded view of the adjustable height lift platform of FIG. 1 showing the base platform separated from the remaining components of the lift platform; and

FIG. 9 is a first side view of the adjustable lift platform of FIG. 1 shown in use on a floor with a surgeon standing on the upper surface of the upper platform.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show a certain configuration for the lifting mechanism utilized with the adjustable height lift platform and generally discuss use of the platform with certain surgical procedures, those skilled in the art will readily understand that this is merely for purposes of simplifying the present disclosure and that the present invention is not so limited.

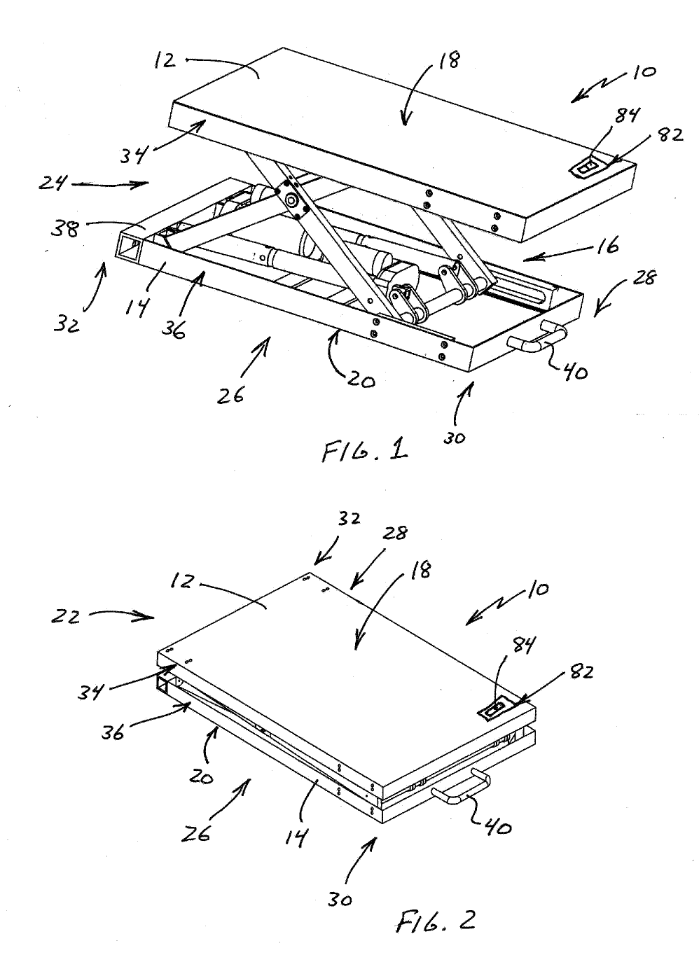

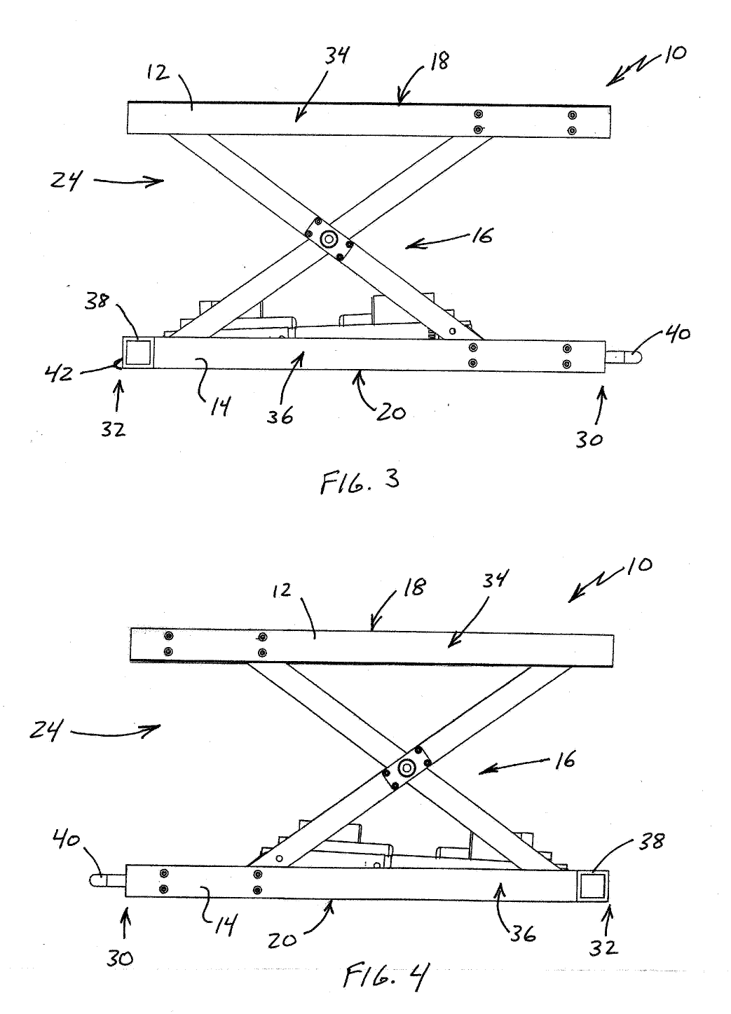

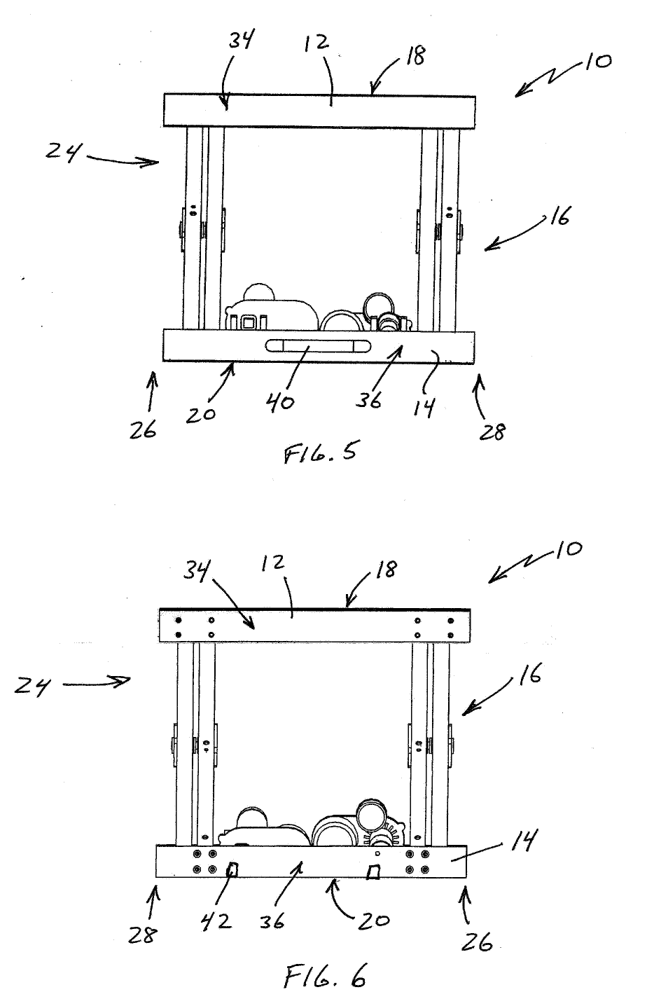

An adjustable height lift platform that is configured pursuant to one embodiment of the present invention is shown generally as 10 in the figures. The adjustable height lift platform 10 of the present invention is configured for use by a surgeon S, shown in FIG. 9, while performing a surgical procedure, such as laparoscopic surgery, on a patient laying or otherwise supported on an operating table or other patient supporting apparatus. As set forth in more detail below, the lift platform 10 of the present invention allows the surgeon S to adjust his or her height relative to the patient (and above floor FL, as shown in FIG. 9) so the surgeon S can more comfortably, safely, effectively and efficiently perform the surgery. By adjusting his or her height to the most comfortable and useful position, the surgeon S will reduce the strain and other discomfort on his or her shoulders, back, neck, wrists and/or other body parts. The lift platform 10 of the present invention generally comprises an upper platform 12, a base platform 14 and a lifting mechanism 16 operatively interconnecting the upper platform 12 and the base platform 14, as best shown in FIGS. 1 and 2 through 6. The upper platform 12 has an upper surface 18 on which the surgeon S stands and the base platform 14 has a lower surface 20 that is placed on the floor FL of the operating or other room in which the surgery is taking place. As described below, the lifting mechanism 16 is configured to selectively move the lift platform 10 between a collapsed position 22, shown in FIG. 2, and its fully raised position 24, shown in FIGS. 1 and 3 through 6, with the surgeon S or other user standing on the upper surface 18 of upper platform 12. Although a variety of shapes can be utilized for lift platform 10, in a preferred embodiment the upper 12 and base 14 platforms are generally elongated shapes, such the rectangular shapes shown in the figures, to allow the surgeon S room to move left and right on the upper surface 18 of upper platform 12 when he or she is standing next to a patient laying on an operating table. In the preferred embodiment, the upper platform 12 and base platform 14 are generally the same size and shape such that in the collapsed position 22 the lift platform 10 is relatively low and compact for ease of moving and storage. In the embodiment shown, the lift platform 10 has a left or first side 26, an opposing right or second side 28, a front or first end 30 and a back or second end 32, as best shown in FIGS. 1 and 2.

In the preferred embodiment, the upper platform 12 has one or more peripherally disposed downwardly extending sidewalls 34 and the base platform 14 has one or more peripherally disposed upwardly extending sidewalls 36, as best shown in FIG. 1. The sidewalls 34 and 36 support and visually shield some of the components of lifting mechanism 16 and provide additional structural support for the upper platform 12 and the base platform 14. In an alternative embodiment, one or more of the upper 12 and base 14 platforms are substantially flat (no sidewalls 34 or 36). In the preferred embodiment, the sidewall 36 at the second end 32 of the base platform 14 is strengthened, such as using a tubular member 38 or other strengthening member(s) or element(s), to provide support for operation of the lifting mechanism 16, as set forth in more detail below.

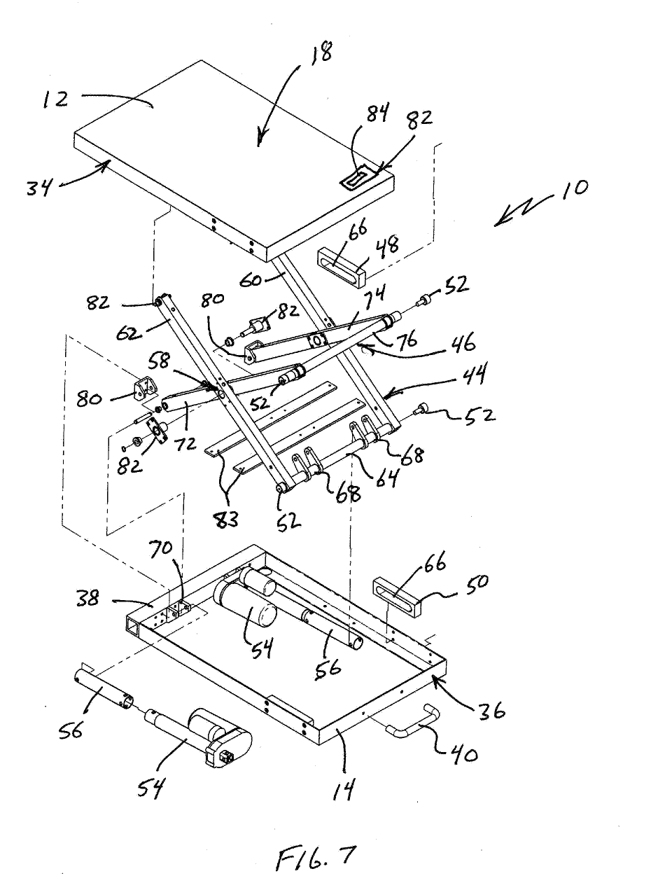

The preferred embodiment of lift platform 10 also includes a handle 40 on the sidewall 34 at the first end 30 of the base platform 14, as best shown in FIGS. 1 and 5, and one or more wheels 42 rotatably attached to the sidewall 36 at the second end 32 of the base platform 14, as best shown in FIGS. 3, 4 and 6, to assist a person with moving the lift platform 10 between its stored position, which will typically be in a convenient storage location in the operating room, and a position next to the operating table. The wheels 42 should be attached to base platform 14 in a manner that allows wheels 42 to rotate across the floor FL when a person tilts the lift platform 10 upward at the first end 30 by grasping handle 40 and pulls the lift platform 10 into position for use. As well known in the art, the one or more wheels 42 should also be attached such that they allow the lower surface 20 of the base member 14 to lay flat on the floor FL and do not cause the lift platform 10 to move when it is laying flat on the floor FL (e.g., particularly when the surgeon S is standing on the upper surface 18 of the upper platform 12). In the embodiment shown, a pair of spaced apart wheels 42 are rotatably attached to the tubular member 38 just above the plane of the floor FL on which the lower surface 20 contacts. If desired, a wheel locking mechanism, examples of which are well known in the art, can be utilized to allow a person to lock the wheels 42 in a fixed, non-rotating condition when the lift platform 10 is in use and unlock the wheels 42 to permit rotation thereof for moving the lift platform 10.

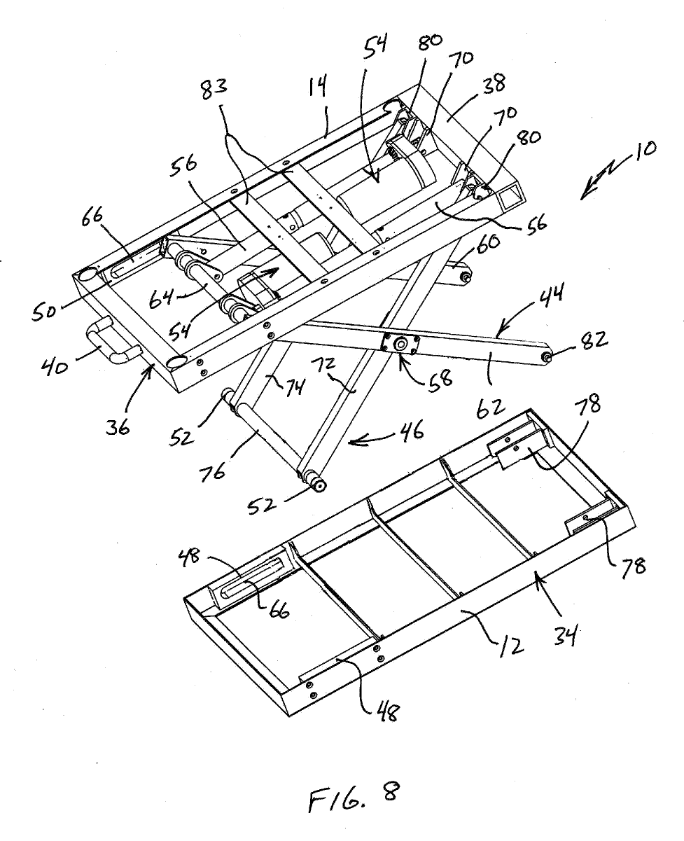

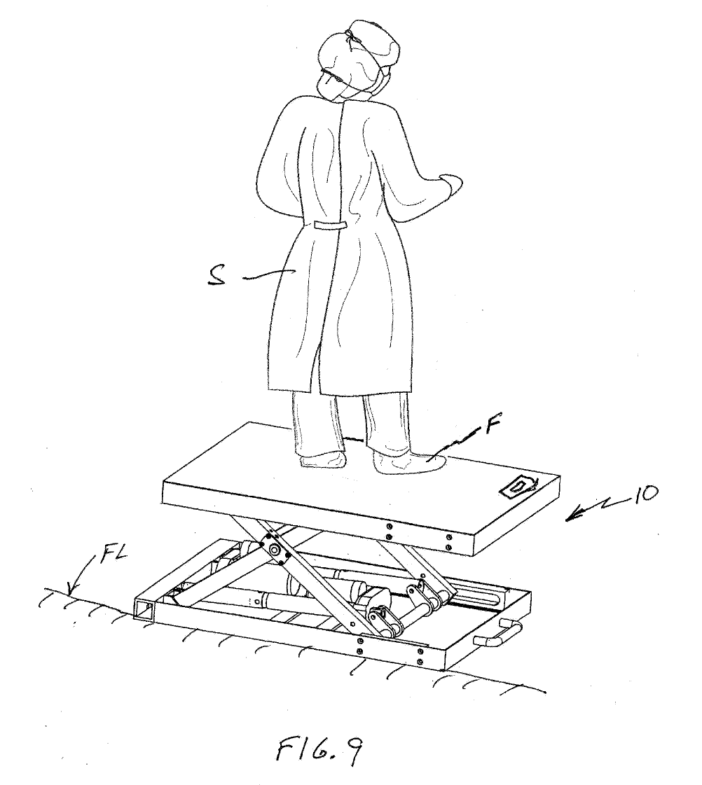

In a preferred embodiment, the lifting mechanism 16 is a scissor type mechanism that allows the surgeon S standing on the upper surface 18 to smoothly move the upper platform 12 up and down to place the lift platform between its raised position 24 and its collapsed position 22, as best illustrated in FIGS. 1 and 2, respectively. In the preferred embodiment, the scissor lifting mechanism 16 comprises a first linkage assembly 44, a second linkage assembly 46, a pair of upper slotted tracks 48 and a pair of lower slotted tracks 50, ball bearing cam followers 52 that move in the slotted tracks 48/50 and one or more linear actuators 54 that each have actuator extensions 56, as best shown in FIGS. 7 and 8. The first linkage assembly 44 is pivotally connected to the second linkage assembly 46 with a pivot assembly 58 such that movement of the lower end of the linkage assemblies 44/46 by the linear actuators 54, via actuator extensions 56, causes the two linkage assemblies 44/46 to fold downward or upward in a scissor-like manner. The first linkage assembly 44 comprises a first linkage member 60, a second linkage member 62 and a cross-member 64 that connects the lower ends of the first 60 and second 62 linkage members. A ball bearing cam follower 62 is positioned at the ends of the cross-member 64 and are slidably received in the slots 66 of the lower slotted tracks 50. A pair of brackets 68 are attached to the cross-member 64, one of which connects to the actuator extension 56 of one linear actuator 54 and the other of which connects to the linear actuator 54 at the end opposite its actuator extension 56 (which connects to a bracket 70 attached to tubular member 38. The second linkage assembly 46 comprises a first linkage member 72, a second linkage member 74 and a cross-member 76 that connects the upper ends of the first 72 and second 74 linkage members. A ball bearing cam follower 62 is positioned at the ends of the cross-member 76 and are slidably received in the slots 66 of the upper slotted tracks 48. The bracket 68 on cross-member 64 of the first linkage assembly 44 connects to one end of the linear actuator 54 and the distal end of the actuator extension 56 associated therewith connect to the brackets 70 at the tubular member 38. The upper ends of the first 60 and second 62 linkage members of the first linkage assembly 44 pivotally connect to fixed brackets 78 attached to the second end 32 of the upper platform 12 and the lower ends of the first 72 and second 74 linkage members of the second linkage assembly 46 pivotally connect to fixed brackets 80 attached to the second end 32 of the base platform 14, as best shown in FIGS. 7 and 8. Pivoting elements 82 are used to connect the various linkage members to their respective fixed brackets 78/80. The ball bearing cam followers 62 and slots 66 are sized and configured to allow the cam followers 62 to move within the upper 48 and lower 50 slotted tracks a sufficient distance to allow the lift platform 10 to move back and forth between its collapsed position 22 and its raised position 24.

In a preferred embodiment, the first 44 and second 46 linkage assemblies are joined with stainless steel machined pivot assembly 58 and travel on the ball bearing cam followers 52 disposed in Delrin slotted tracks 48/50. In a preferred embodiment, the linear actuators 54 are two 500#, four inch stroke, 120 volt linear actuators, with 120 volt power supplied by a junction box that splits power to each linear actuator 54, to provide approximately eighteen inches of fully extended raised position 24. A power cord, not shown, connects the junction box to a supply of power. As shown in FIGS. 7 and 8, a pair of junction box mount bars 83 are used to support the junction box which provides power to the linear actuators 54. Preferably, the lift platform 10 will include a vinyl cover or other device to store the power cord in when the lift platform 10 is not in use. In one embodiment, the linkage assemblies 44/46 are sized and configured to provide a stored height of approximately six inches. As will be understood by those skilled in the art, the actuator extensions 56 move linearly in response to operation of the linear actuators 54 to extend or retract and move the first 44 and second 46 linkage assemblies in a scissor like manner to cause the upper platform 12 to move up or down relative to the base platform 14.

The lift platform 10 also includes a switch operating mechanism 84 that is configured and positioned to allow the surgeon S standing on the upper surface 18 of the upper platform 12 to control the up and down movement of the upper platform 12. Preferably, the switch operating mechanism 84 is of the type that works with the linear actuators 54 to provide virtually infinite positioning of the upper platform 12 so the surgeon S standing thereon can place himself or herself in the most comfortable position relative to the patient laying on an operating table next to where the lift platform 10 is placed. In the preferred embodiment, the switch operating mechanism 84 includes a switch 86 that is mounted in or attached to the upper surface 18 of the upper platform 12, as best shown in FIGS. 1, 2 and 7. The switch 86 of switch operating mechanism 84 is operatively connected to the linear actuators 54 to allow controlled movement of the actuator extensions 56 to move the first 44 and second 46 linkage assemblies in their scissor-like manner (via the pivot assembly 58 that interconnects the two linkage assemblies 44/46) to cause the upper platform 12 to move up and down relative to the base platform 14. In a preferred embodiment, the switch operating mechanism 84 comprises a side-to-side paddle switch 86. In an alternative embodiment, the switch operating mechanism 84 can comprise an infrared dual action foot pedal transmitter mounted on the upper platform 12 that is operatively connected, such as wired or wirelessly connected to a receiver mounted under the upper platform 12. Various other types of switch operating mechanisms 84 can be utilized with the lift platform 10 of the present invention. Preferably, however, any such switch operating mechanism 84 is either foot operated or otherwise configured so the surgeon S does not have to use his or her hand to operate the switch operating mechanism 84, which would contaminate his or her hand and require re-sterilization, to move the upper platform 12 up or down as needed or desired. In an alternative embodiment, the switch operating mechanism 84 can be mounted on a post or other member and placed at a height where the surgeon S can use an elbow or another part of his or her body to operate the switch 86 that controls the movement of the upper platform 12.

In the preferred embodiment, the structural components of the lift platform 10, including the upper platform 12, base platform 14 and various support members of the lifting mechanism 16, are made out of angle members, rectangular tubing and round tubing that are welded or otherwise fixedly attached, as appropriate for the materials utilized, together for strength. Alternatively, various connecting elements, including screws, bolts, rivets and the like may be used to connect the components together. Preferably, these components are made out of aluminum or other lightweight materials, including various composite materials, so the overall weight of the lift platform 10 will be as low as possible yet strong enough to support the weight of a surgeon S. In one embodiment, the lift platform 10 of the present invention is configured to support approximately 300 pounds. The preferred embodiment of the lift platform 10 will include a ribbed rubber mat or like material on the upper surface 18 to provide a non-slip surface on which the surgeon S can stand while using the lift platform 10. In addition, preferably the lower surface 20 of the base platform 14 will also comprise a ribbed rubber mat or like material thereon to prevent undesired movement of the base platform relative to the floor FL.

In use, a nurse or surgery assistant will move the lift platform 10 from its stored position to a position next to the operating table on which the patient is positioned for the surgeon S to perform the desired surgery. The nurse/assistant will grasp the handle 40, raise the first end 30 thereof and pull the lift platform into position by rolling it across the floor FL on the wheels 42. When the surgeon S is ready to start the surgery, he or she will step onto the upper surface 18 of the upper platform 12 and engage the switch operating mechanism 84, preferably with his or her foot F, to raise the upper platform 12 to the desired height, which will be where the surgeon S can comfortably perform the surgery. The switch operating mechanism 84 will activate the linear actuators 54 to extend the actuator extensions 56 and cause the linkage assemblies 44 and 46 to move in a scissor-like manner with the respective ends of the linkage members 60/62/72/74 having the cam followers 52 in the slots 66 of the upper 48 and lower 50 slotted tracks. The surgeon S can deactivate the switch operating mechanism 84 to stop precisely at the height where he or she is the most comfortable to perform the surgery. Once the surgery is complete, the surgeon S again engages the switch operating mechanism 84 to lower the upper platform 12 toward the base platform 14 until it is at its collapsed position 22, where the surgeon S can step off of the lift platform 10. A nurse or assistant then grabs the handle 40 and raises the first end 30 of the lift platform 10 to roll the lift platform 10 on its wheels 42 away from the operating table and to its stored position, which will typically be somewhere in the operating room so that it will be readily available for the next use thereof.

While there are shown and described herein a specific form of the invention, it will be readily apparent to those skilled in the art that the invention is not so limited, but is susceptible to various modifications and rearrangements in design and materials without departing from the spirit and scope of the invention.

In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. An adjustable height lift platform for use in a surgical procedure by a surgeon performing the surgical procedure, said lift platform comprising:
a base platform having a lower surface configured to rest on a floor;
an upper platform having an upper surface configured for a surgeon to stand thereon while performing the surgical procedure;
lifting means interconnecting said base platform and said upper platform for raising and lowering said upper platform relative to said base platform so as to move said lift platform between a collapsed position and a raised position; and
switch operating means mounted on said lift platform and operatively connected to said lifting mechanism for operating said lifting mechanism so as to move said lift platform between said collapsed position and said raised position so as to raise and lower the surgeon on said upper platform relative to the floor.

2. The lift platform of claim 1, wherein said switch operating means is associated with said upper platform.

3. The lift platform of claim 2, wherein said switch operating means is disposed in said upper surface of said upper platform and operated by a foot of the surgeon.

4. The lift platform of claim 1, wherein said base platform comprises one or more peripherally disposed upwardly extending sidewalls.

5. The lift platform of claim 1, wherein said upper platform comprises one or more peripherally disposed downwardly extending sidewalls

6. The lift platform of claim 1, wherein said base platform comprises a handle at a first end thereof and one or more wheels at a second end thereof.

7. The lift platform of claim 1, wherein said lifting means comprises at least one linkage assembly connected to said upper platform and at least one linear actuator interconnecting said linkage assembly and said base platform.

8. The lift platform of claim 1, wherein said lifting means comprises a first linkage assembly, a second linkage assembly and a pivot assembly pivotally interconnecting said first linkage assembly and said second linkage assembly.

9. The lift platform of claim 8, wherein said lifting means further comprises one or more linear actuators operatively connected to each of said first linkage assembly and said second linkage assembly, each of said linear actuators configured to extend or retract so as to pivot said first linkage assembly and said second linkage assembly.

10. The lift platform of claim 9, wherein said lifting means further comprises one or more cam followers associated with each of said first linkage assembly and said second linkage assembly, each of said one or more cam followers engagedly received in a slot of a slotted track.

11. The lift platform of claim 1, wherein said lifting means comprises a first linkage assembly, a second linkage assembly, one or more upper slotted tracks at said upper platform, one or more lower slotted tracks at said base platform, one or more cam followers associated with said first linkage assembly and received in a slot of said lower slotted tracks, one or more cam followers associated with said second linkage assembly and received in a slot of said upper slotted track and a pivot assembly pivotally interconnecting said first linkage assembly and said second linkage assembly.

12. An adjustable height lift platform for use in a surgical procedure by a surgeon performing the surgical procedure, said lift platform comprising:
a base platform having a lower surface configured to rest on a floor;
an upper platform having an upper surface sized and configured for a surgeon to stand thereon while performing the surgical procedure;
lifting means interconnecting said base platform and said upper platform for raising and lowering said upper platform relative to said base platform so as to move said lift platform between a collapsed position and a raised position, said lifting means having at least one linkage assembly connected to said upper platform and at least one linear actuator interconnecting said linkage assembly and said base platform; and
switch operating means mounted on or disposed in said upper surface of said upper platform and operatively connected to said lifting mechanism for operating said lifting mechanism so as to move said lift platform between said collapsed position and said raised position so as to raise and lower the surgeon on said upper platform relative to the floor, said switch operating means operated by a foot of the surgeon.

13. The lift platform of claim 12, wherein said base platform comprises a handle at a first end thereof and one or more wheels at a second end thereof.

14. The lift platform of claim 12, wherein said lifting means comprises a first linkage assembly, a second linkage assembly and a pivot assembly pivotally interconnecting said first linkage assembly and said second linkage assembly.

15. The lift platform of claim 14, wherein said lifting means further comprises one or more linear actuators operatively connected to each of said first linkage assembly and said second linkage assembly, each of said linear actuators configured to extend or retract so as to pivot said first linkage assembly and said second linkage assembly.

16. The lift platform of claim 15, wherein said lifting means further comprises one or more cam followers associated with each of said first linkage assembly and said second linkage assembly, each of said one or more cam followers engagedly received in a slot of a slotted track.

17. An adjustable height lift platform for use in a surgical procedure by a surgeon performing the surgical procedure, said lift platform comprising:
a base platform having a lower surface configured to rest on a floor;
an upper platform having an upper surface sized and configured for a surgeon to stand thereon while performing the surgical procedure;
lifting means interconnecting said base platform and said upper platform for raising and lowering said upper platform relative to said base platform so as to move said lift platform between a collapsed position and a raised position, said lifting means having a first linkage assembly, a second linkage assembly, one or more upper slotted tracks at said upper platform, one or more lower slotted tracks at said base platform, one or more cam followers associated with said first linkage assembly and received in a slot of said lower slotted tracks, one or more cam followers associated with said second linkage assembly and received in a slot of said upper slotted track and a pivot assembly pivotally interconnecting said first linkage assembly and said second linkage assembly; and
switch operating means mounted on or disposed in said upper surface of said upper platform and operatively connected to said lifting mechanism for operating said lifting mechanism so as to move said lift platform between said collapsed position and said raised position so as to raise and lower the surgeon on said upper platform relative to the floor, said switch operating means operated by a foot of the surgeon.

18. The lift platform of claim 17, wherein said base platform comprises one or more peripherally disposed upwardly extending sidewalls and said upper platform comprises one or more peripherally disposed downwardly extending sidewalls.

19. The lift platform of claim 17, wherein said base platform comprises a handle at a first end thereof and one or more wheels at a second end thereof.

20. The lift platform of claim 17, wherein each of said first linkage assembly and said second linkage assembly comprises a first linkage member, a second linkage member and a cross-member interconnecting said first linkage member and said second linkage member.
